(19) United States
(12) Patent Application Publication
(10) Pub. No.: US 2012/0244449 A1
(43) Pub. Date: Sep. 27, 2012

(54) CONTAINER ARRANGEMENT FOR A FUEL CELL SYSTEM, AND METHOD FOR INTRODUCING AN ION EXCHANGE MODULE IN A COOLANT CONTAINER

(75) Inventors: Mario Mittmann, Owen (DE); Stephan Neupert, Stuttgart (DE); Wolfgang Schwienbacher, Dettingen (DE)

(73) Assignee: DAIMLER AG, Stuttgart (DE)

(21) Appl. No.: 13/501,795

(22) PCT Filed: Sep. 11, 2010
(86) PCT No.: PCT/EP2010/005582

§ 371 Date: Jun. 11, 2012

(30) Foreign Application Priority Data
Oct. 14, 2009 (DE) 102009049428.6

(51) Int. Cl. H01M 8/04

(52) U.S. Cl. 429/434; 429/535

(57) ABSTRACT

A container arrangement (1) for a fuel cell system with a coolant container (2) and a module (5) with an ion exchanger material (7) which can be incorporated via an introduction opening (4) into the coolant container (2). The module (5) has a protective shell (8), via which upon incorporation of the module (5) into the coolant container (2) the introduction opening (4) can be sealed with respect to an environment of the coolant container (2). A method for incorporating a module (5) comprising an ion exchanger medium (7) into a coolant container (2) for a fuel cell system is also disclosed. The protective shell (8) can be removed from the coolant container (2) after incorporation of the module (5).

The invention relates to a container arrangement for a fuel cell system, with a coolant container and a module comprising an ion exchanger material which can be incorporated into the coolant container via an opening. The invention further relates to a method for incorporating a module comprising an ion exchanger material into a coolant container for a fuel cell system, wherein an opening is exposed in the coolant container.

EP 2 025 028 B1 describes a fuel cell system with a cooling circuit for cooling the fuel cell stack. A coolant flowing in the cooling circuit is deionised by means of an ion exchanger. It is thereby ensured that a current flow does not take place between the individual cells of the fuel cell stack via the coolant. The deionising resin which serves to reduce the electrical conductivity of the coolant is kept in a sack or similar container. The sack is introduced through a filling opening into a coolant compensating container arranged in the cooling circuit. The filling opening of the coolant compensating container is closed after incorporation of the sack with a screw closure.

The fact that exchange of the container comprising the deionising resin can easily lead to undesired contamination of the coolant is hereby regarded as disadvantageous. Such contaminations generally increase the electrical conductivity of the coolant, which at least reduces the degree of efficiency of a fuel cell system. Under unfortunate circumstances a contamination can lead to a short circuit, damage to the fuel cell system or a serious electrical risk to the environment of the fuel cell system. Contaminations of the coolant must therefore be avoided as extensively as possible under all circumstances.

JP 2004 311347 A1 further describes a coolant container for a fuel cell system which comprises a removable lid. A plate-like module is arranged at the bottom of the coolant container which contains an ion exchanger resin. In order to exchange the module the lid can be removed from the coolant container and the module removed. The coolant located in the coolant container can be previously discharged.

Completely emptying the coolant container when exchanging the module is impractical and the removal of the module from the unemptied coolant container conceals a high contamination risk for the coolant.

It is thus an object of the invention to create a container arrangement and a method of the type described above, by means of which a contamination of the coolant can be particularly extensively avoided.

This object is achieved through a container arrangement having the features of claim 1 and through a method having the features of claim 7. Advantageous embodiments with useful further developments of the invention are indicated in the respectively dependent claims.

The container arrangement according to the invention for a fuel cell system comprises a coolant container and a module which comprises an ion exchanger material or ion exchanger medium. The coolant container serves as a compensating container for the coolant, by means of which a fuel cell stack of the fuel cell system is cooled. The module can be incorporated via an opening into the coolant container. A protective shell for the module is provided, by means of which upon incorporation of the module into the coolant container the opening can be sealed with respect to an environment of the coolant container.

The protective shell thus ensures protection of the module against contamination before incorporation of the module into the coolant container, for example during transport of the module. In addition the protective shell of the module protects the opening during incorporation of the module into the coolant container in such a way that no substance contaminating the coolant can pass from the environment of the coolant container via the opening into the coolant container. Upon replacement of a used module by a new module, which is hereby incorporated into the coolant container via the opening, the opening is thus closed in a contamination-proof way through the protective shell. Upon incorporation of the module into the coolant container the module is additionally protected through the protective shell against contact, for example by an assembler or similar person handling the module, and thus protected against contamination. A contamination of the coolant can thus be avoided particularly extensively.

In an advantageous embodiment of the invention the protective shell comprises at least one sealing element which can be pushed onto a nozzle of the coolant container comprising the opening and/or inserted into it and/or screwed onto it on the inner peripheral or outer peripheral side. Through such a sealing element integrated into the protective shell it is possible in a particular simple way to seal the opening of the coolant container upon incorporation of the module into the coolant container.

According to a further aspect of the invention a contamination of the coolant can be at least extensively avoided in a method for incorporating a module comprising an ion exchanger medium into a coolant container for a fuel cell system, wherein an opening is exposed in the coolant container and wherein by means of a protective shell of the module upon incorporation of the module into the coolant container the opening is sealed with respect to an environment of the coolant container. The protective shell protecting the module against contamination can serve as transport packaging which then closes the opening of the coolant container in a contamination-proof way upon incorporation of an unused module into the coolant container.

It has hereby been shown to be further advantageous if the protective shell is removed from the coolant container after incorporation of the module into the coolant container, in particular by being taken off or unscrewed. The protective shell has fulfilled its function after incorporation of the module into the coolant container and does not cause further interference if it is removed from the coolant container.

The advantages and preferred embodiments described for the container arrangement according to the invention are also valid for the method according to the invention and vice versa.

The features and feature combinations mentioned above in the description and the features and feature combinations mentioned below in the description of the drawings and/or shown only in the drawings can be used not only in the respectively indicated combination but also in other combinations or alone without going outside of the scope of the invention.

Further advantages, features and details of the invention follow from the claims, the following description of preferred embodiments and by reference to the drawings, in which:

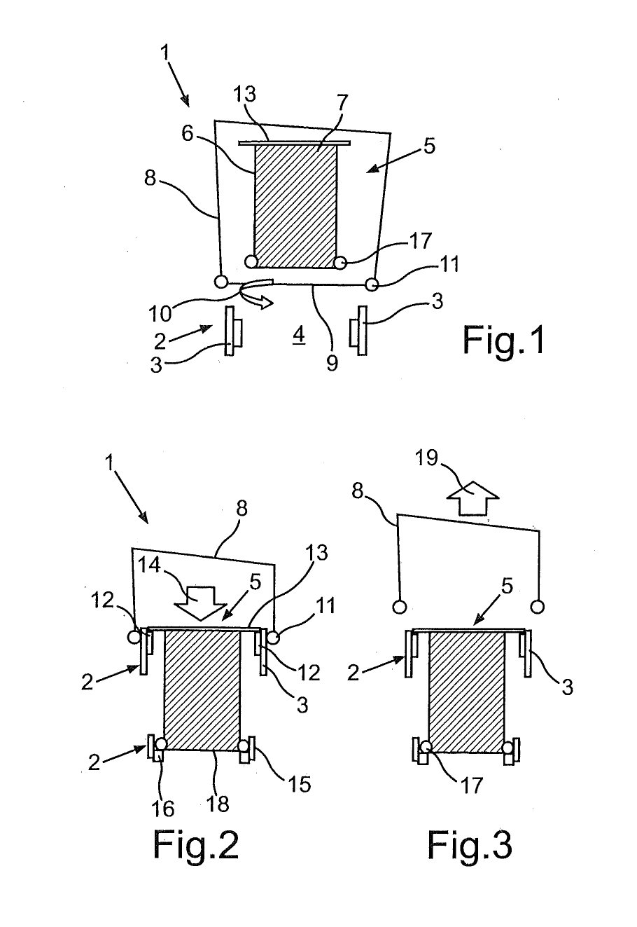

FIG. 1: shows in a cut-out and in a sectional view a coolant container, into which an ion exchanger module is to be incorporated;

FIG. 2: shows, schematically, the coolant container with an ion exchanger module incorporated into the coolant container; and

FIG. 3: shows the removal of a protective shell of the ion exchanger module from the coolant container.

FIG. 1 shows in a cut-out a container arrangement 1 for a fuel cell system. The container arrangement comprises a coolant container 2 which serves as a compensating container for a coolant for cooling a fuel cell stack of the fuel cell system. FIG. 1 shows merely a nozzle 3 of the coolant container 2 which delimits an introduction opening 4. The introduction opening 4 is dimensioned so that an ion exchanger module 5 can be incorporated into the coolant container 2 by means thereof.

The ion exchanger module 5 comprises a cylindrical receptacle 6, in which an ion exchanger material 7 is kept. The ion exchanger module 5 is surrounded by a protective shell 8 which protects the ion exchanger module 5 against contamination during transport. A bottom 9 of the protective shell 8 can be separated from the protective shell 8, for example by tearing. The separation of the bottom is illustrated in FIG. 1 by a movement arrow 10. The protective shell 8 additionally comprises a sealing ring 11 which can be pushed onto the nozzle 3 of the coolant container 2 after separation of the bottom 9.

FIG. 2 shows the container arrangement 1, wherein the protective shell 8 for the ion exchanger module 5 has been pushed onto the nozzle 3 of the coolant container 2. The sealing ring 11 hereby seals the introduction opening 4 of the coolant container 2 with respect to an environment of the coolant container 2 in a contamination-proof way.

As a supplement or an alternative to sealing the introduction opening 4 of the coolant container 2 by pushing on the sealing ring 11 it can be provided that the protective shell 8 can be screwed onto the nozzle 3. The sealing ring 11 can hereby be guided in an inner thread or in an outer thread of the nozzle 3. Alternatively a sealing ring lying on the nozzle 3 on the inner peripheral side and the sealing ring 11 lying on the outer peripheral side can be provided.

In the region of the nozzle 3 guide rails 12 are provided on the coolant container 2 which ensure that the ion exchanger module 5 can be incorporated in the correct position in the coolant container 2.

A lid 13 of the ion exchanger module 5 delimits the incorporation of the ion exchanger module 5 into the coolant container 2 in the direction of the arrow 14 shown in FIG. 2 in that the lid 13 runs onto the guide rails 12—then acting as a stop. As an alternative to the lid 13 another type of stop can also be provided on the ion exchanger module 5.

The lid 13 can also serve directly for the contamination-proof closure of the nozzle 3 as soon as the protective shell 8 has been removed from the coolant container 2 for example by taking off or unscrewing (cf FIG. 3). However, a separate lid can also be provided to close the nozzle 3 after removal of the protective shell 8, for example a lid which can be screwed onto the nozzle 3. It can also be provided that the lid 13 is incorporated, for example by means of a bayonet closure, on the ion exchanger module 5 inserted into the coolant container 2 in order to close the introduction opening 4.

If a separate lid is provided this can be connected in a releasable or non-releasable way to the ion exchanger module 5, for example by being screwed onto the lid 13. The separate lid can for example be delivered screwed on the ion exchanger module 5 in the receptacle 6. Through this separate lid there is the advantageous possibility of packing the ion exchanger module 5 aptly on the separate lid, for example screwing on the separate lid (with ion exchanger module fixed thereon) and removing the ion exchanger module 4 together with the separate lid from the introduction opening. During subsequent incorporation of the replacement ion exchanger module 5 this can in turn be aptly packed together with the surrounding receptacle 6 on the separate lid and (with separate lid fixed thereon) introduced into the introduction opening 4. After engagement of the ion exchanger module 5 in the provided position the separate lid can then be screwed again, for example to the nozzle 3. This allows a particularly efficient and contamination-proof exchange of the ion exchanger module 5.

FIGS. 2 and 3 show merely the upper region of the coolant container 2 comprising the nozzle 3 and a lower region which also comprises a guide 15 for the ion exchanger module 5. In the region of the guide 15 an engagement means 16 is additionally advantageously provided. The engagement means 16 serves on the one hand for engagement of the ion exchanger module 5 with the coolant container 2. On the other hand the engagement means 16 forms a stop upon incorporation of the ion exchanger module 5 into the coolant container 2. Upon engagement of the ion exchanger module 5 with the compensating container 2 a sealing ring 17 arranged on the lower side on the ion exchanger module 5 serves in the present case for a sealed positioning of the ion exchanger module 5 in the coolant container 2. It is thus possible for a bottom of the coolant container 2 to be formed at least in areas by a bottom 18 of the ion exchanger module 5.

The sealing ring 17 further ensures that upon entry of the coolant to be conveyed via the ion exchanger material 7 into the coolant container 2 a flow path can be predefined through the ion exchanger module 5. It is thus possible for the coolant to flow through the ion exchanger module 5 from bottom to top or from top to bottom in order to bring about a deionisation of the coolant. The cylindrical form of the ion exchanger module 5 and its upright orientation in the coolant container 2 are hereby advantageous.

FIG. 3 shows the removal of the protective shell 8 from the nozzle 3 of the coolant container 2 through a further movement arrow 19.

In order to be able to easily remove the ion exchanger module 5 from the coolant container 2 when the ion exchanger material 7 has been used up, a handle (not shown) or similar handling element can be provided on the ion exchanger module 5. For example the handle can be lowered before exchange of the ion exchanger module 5 into the ion exchanger module 5 and then removed from it for handling of the ion exchanger module 5.

As a supplement or an alternative a receiving area for a dismantling tool can be provided on the ion exchanger module 5, for example a correspondingly marked point, which can be penetrated by means of the dismantling tool in order to then remove the ion exchanger module 5 from the coolant container 2. The dismantling tool can hereby be formed so that it can be connected to the ion exchanger module 5 through insertion and/or rotation thereof into the ion exchanger module 5.

By providing the removable protective shell 8, upon incorporation of the ion exchanger module 5 into the coolant container 2 said coolant container 2 is exposed at most for a minimum time, namely until the introduction opening 4 has been closed again after removal of the protective shell 8, to a contamination from an environment of the coolant container 2. Particularly if the lid 13 of the ion exchanger module 5 ensures the sealing of the coolant container 2 the introduction opening 4 is even closed in a contamination-proof way already upon removal of the protective shell 8 from the nozzle 3.

1. A container arrangement for a fuel cell system, with a coolant container (2) and with a module (5) comprising an ion exchanger material (7) which can be incorporated into the coolant container (2) via an opening (4),
wherein a protective shell (8) is provided for the module (5), by means of which upon incorporation of the module (5) into the coolant container (2) the opening (4) can be sealed with respect to an environment of the coolant container (2).

2. The container arrangement according to claim 1, wherein the protective shell (8) comprises at least one sealing element (11) which can be pushed onto a nozzle (3) of the coolant container (2) comprising the opening (4) and/or can be inserted into it and/or screwed onto it on the inner peripheral side or outer peripheral side.

3. The container arrangement according to claim 1, wherein at least one stop (12, 13, 16) is provided on the module (5) and/or on the coolant container (2) to delimit the incorporation of the module (5) into the coolant container (2).

4. The container arrangement according to claim 1, wherein at least one guide (12, 15) is provided for the incorporation of the module (5) into the coolant container (2) in the correct position.

5. The container arrangement according to claim 1, wherein the module (5) incorporated in particular with the formation of a seal seat into the coolant container (2) is engaged with the coolant container (2).

6. The container arrangement according to claim 1, wherein the module (5) comprises a handling element, which can be brought in particular into a position of use, and/or a receiving area for a handling element, by means of which the module (5) can be removed from the coolant container (2).

7. A method for incorporating a module (5) comprising an ion exchanger material (7) into a coolant container (2) for a fuel cell system, wherein an opening (4) is exposed in the coolant container (2), wherein by means of a protective shell (8) of the module (5) upon incorporation of the module (5) into the coolant container (2) the opening (4) is sealed with respect to an environment of the coolant container (2).

8. The method according to claim 7, in that, wherein the protective shell (8) is removed from the coolant container (2) after incorporation of the module (5) into the coolant container (2), in particular by taking off or unscrewing.
